(19) United States
(12) Patent Application Publication
(10) Pub. No.: US 2007/0020976 A1
(43) Pub. Date: Jan. 25, 2007

(54) Methods and apparatus for proving secure communication ports using a universal port device

(76) Inventor: Idham Tirtosupono, Bethesda, MD (US)

Correspondence Address: Idham Tirtospono, 7820 Royal Dominion Dr., Bethesda, MD, 20917, US

(21) Appl. No.: 11/187,803

(22) Filed: Jul. 25, 2005

(51) Int. Cl. H01R 13/44

(52) U.S. Cl. 439/133

(57) ABSTRACT

A Universal Port Locking Device (UPLD) comprised of a two part modular device (M1 and M2), designed to prevent the unauthorized use of a female modular communication receptacle. As will be shown in more detail in the following descriptions, the UPLD does not require special tools, keys, springs as used in previous designs of communication receptacle locks, and would be more compact, more versatile, more durable, and less expensive to produce than previous communication receptacle locks. The UPLD device provides a physical barrier having a unique shape, altering the access to the female receptacle of standard male coupling connections. In addition, because the UPLD connects to the wire contacts on the surface of the female communication receptacle; it may modify the wiring system alignment of the contacts. Thus, the UPLD provides two barriers of protection from unauthorized access, physical and through circuitry.

### FIELD OF THE INVENTION

This present invention relates to a communication port security device. More particularly, to a Universal Port Locking Device (UPLD) having a two part modular device (M1 and M2), designed to prevent the unauthorized use of a female modular communication receptacle.

### BACKGROUND OF THE INVENTION

Ordinary communication circuits are connected to the communication network system through the use of a standardized modular connectors, such as RJ-11, RJ-14, RJ-45, USB, T1 or fiber receptacle connectors. The modular connectors have different designations depending on the number of electrical contacts within the connector. RJ-11 connectors typically have four electrical contacts and RJ-45 connectors typically have eight electrical contacts. Hereafter, all modular communication connectors will be referred to generically as RJ-SBT connectors. Because of cyber-terrorism, hackers, malware developers (programs to shut down computer systems and/or networks) and new applications of spyware, the separation between cyber and physical security is blurring. Moreover, in recent years, various organizations have begun to run physical security systems on IP networks. However, running non-traditional technologies on such networks has raised concerns about maintenance, performance and security.

The communication network system uses “female” RJ-SBT receptacles as ports which are used to connect communications to the network. Each ordinary communication port also has a female RJ-SBT receptacle. The communication ports are connected to the communication network using a wire which has a “male” RJ-SBT connector that is inserted into the female receptacle. The use of modular RJ-SBT connectors allows communication to easily be connected to and disconnected from the communication network system by users without tools of any kind.

The same RJ-SBT modular connector is used to connect most other communication devices such as telephones, voice and, audio, computer modems, fax machines, answering machines, Personal Digital Assistants (PDAs), computer receptacle ports, internal and external data-hard drives, and video communication ports, etc. to the communication network system; but are not limited to these applications. Each of these devices can now be secured when UPLD (M1) is attached via a female RJ-SBT receptacle. Additionally, said port can be accessed by the insertion of the complementary shaped UPLD (M2) which when inserted would have complementary wiring alignment of UPLD (M1).

The present application concept requires only the attachment of a UPLD to a female RJ-SBT receptacle to secure the network. The present invention is intended, in particular, for use on computer systems with cabled peripheral devices using a voice, data, or video system interface. The use of this interface presents special data security problems, since it is possible to activate file devices from remote units via a female receptacle. In general, systems and peripheral devices using the female receptacle have external connector ports for the attachment of external cables to other devices. Even when such a port is not used, i.e., when it has no attached cable, it constitutes a data security hazard, since the port could be accessed and data obtained through an unauthorized attachment of a remote unit.

One application of such a device is to limit the access to a “live” communication line. In this manner the unauthorized user will not be able to access the communication service ranging from voice to data access of unauthorized use and/or monitoring communication information.

Another possible application of the present invention is to prevent early access to a female RJ-SBT receptacle on a communications device such as a communication, modem, fax machine, or any other device that uses a female RJ-SBT receptacle. For example, a manufacturer may produce a product that provides communication capabilities which are not yet approved for use by the regulatory agency. In such a situation, the manufacturer could plug the female RJ-SBT receptacle with the disclosed device and thereby prevent the use of the communication capabilities on the product until it is approved for use. When the regulatory agency approves of the device, the UPLD (M2), attached to a cable, could be inserted into M1 to access the receptacle.

At times it is desirable to restrict access to female RJ-SBT receptacles in order to prevent the unauthorized use of the receptacle, whether voice, data or video. This is accomplished by the present invention which comprises a specialized UPLD device (M1) which is permanently inserted into a female RJ-SBT receptacle and cannot be removed by ordinary means.

### SUMMARY OF THE INVENTION

The object of the present invention is to provide an apparatus for preventing the unauthorized use of a female RJ-SBT receptacle. Unauthorized use is prevented by physically blocking access to the female RJ-SBT receptacle with a specialized Universal Port Locking Device (UPLD).

It is a further object of the present invention to allow access to the female RJ-SBT receptacle when authorized through the use of a specialized wired adapter device M2.

It is yet a further objective of the present invention to have several designed Universal Port Locking Devices (UPLD) (M1) and a wired adapter device (M2) corresponding set; such that different wired UPLD devices would require a different alignment wired adapter device.

A final objective of the present invention is that the UPLD (M1) remains permanently connected to the female RJ-SBT receptacle with or without attachment of the specialized wired adapter (M2). The UPLD (M1) is comprised of a locking means, permanently connecting M1 to a RJ-SBT receptacle. Thus the UPLD is designed to have specialized locking teeth-like structures, or a contact cement application, such that M1 is irreversibly or permanently connected to the female RJ-SBT receptacle.

All of the above objectives have been achieved in the two part modular UPLD device (M1 and M2).

### BRIEF DESCRIPTION OF DRAWINGS

FIG. 1 is a view of the UPLD (M1) and locking device attached at the top securing into a female RJ-SBT receptacle.

FIG. 2 is a view of the UPLD (M2) locking device which is inserted into (M1) for a communication connection.

FIG. 3 is a view of the locking device which secures UPLD (M1) in a RJ-SBT receptacle.

FIG. 4 is a cross section view of UPLD (M1) secured into a RJ-SBT receptacle.

FIG. 5 is an illustration of the wiring realignment of UPLD (M1), preventing unauthorized use.

FIG. 6 is an illustration of the wiring realignment of UPLD (M2), complementary to (M1) to access communication.

FIG. 7 is an illustration of the potential applications of UPLD (M1 and M2).

### DETAILED DESCRIPTION

A communication Universal Port Locking Device (UPLD) comprising a two part modular device (M1 and M2), is disclosed. The UPLD is made of plastic, rubber-type-compound, or any hard compound which does not (significantly) conduct electricity. In the following description, for purposes of explanation, specific nomenclature is set forth to provide a thorough understanding of the present invention. However, it will be apparent to one skilled in the art that these specific details are not required in order to practice the present invention.

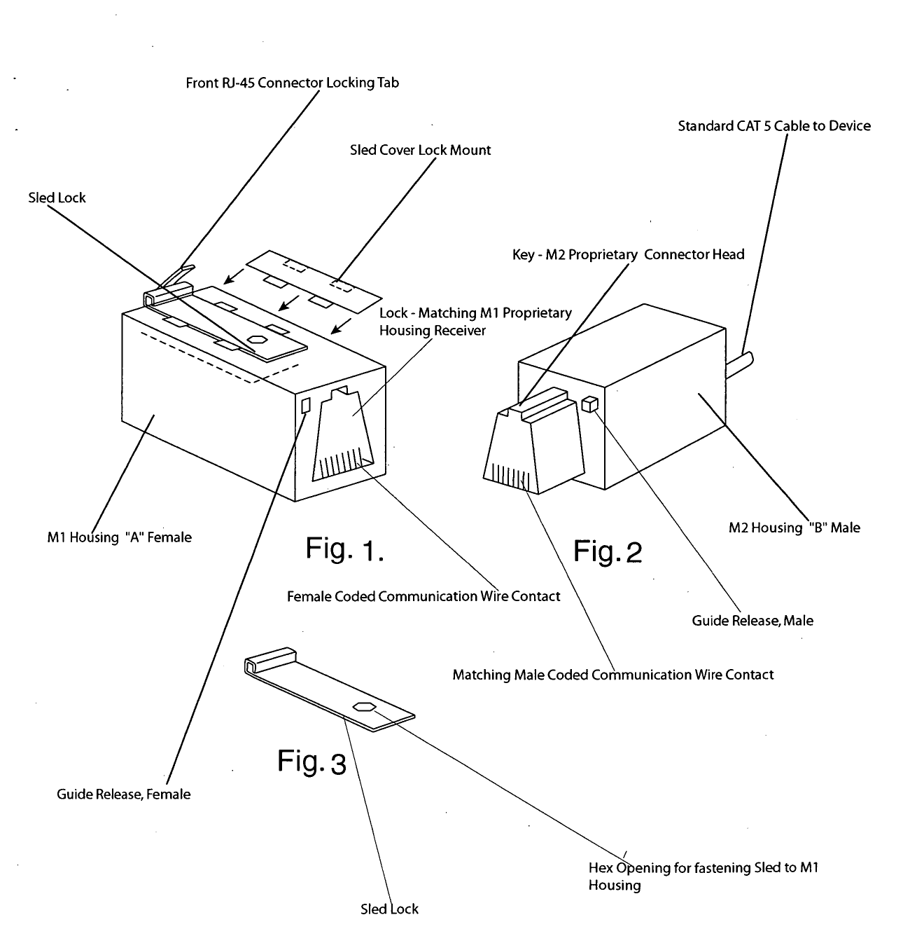

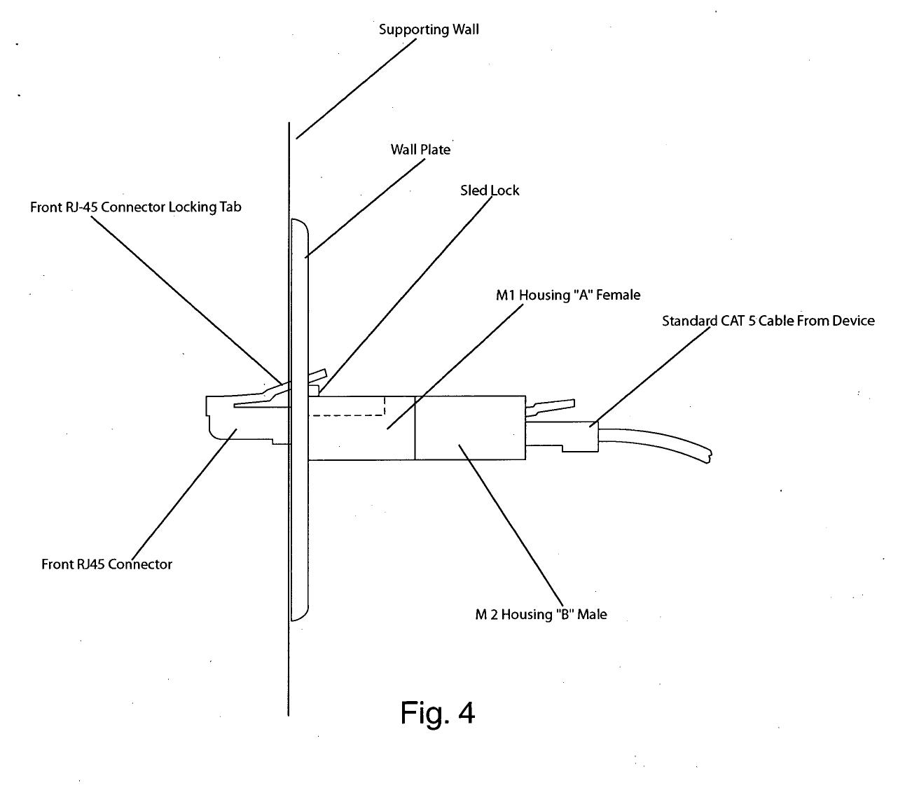

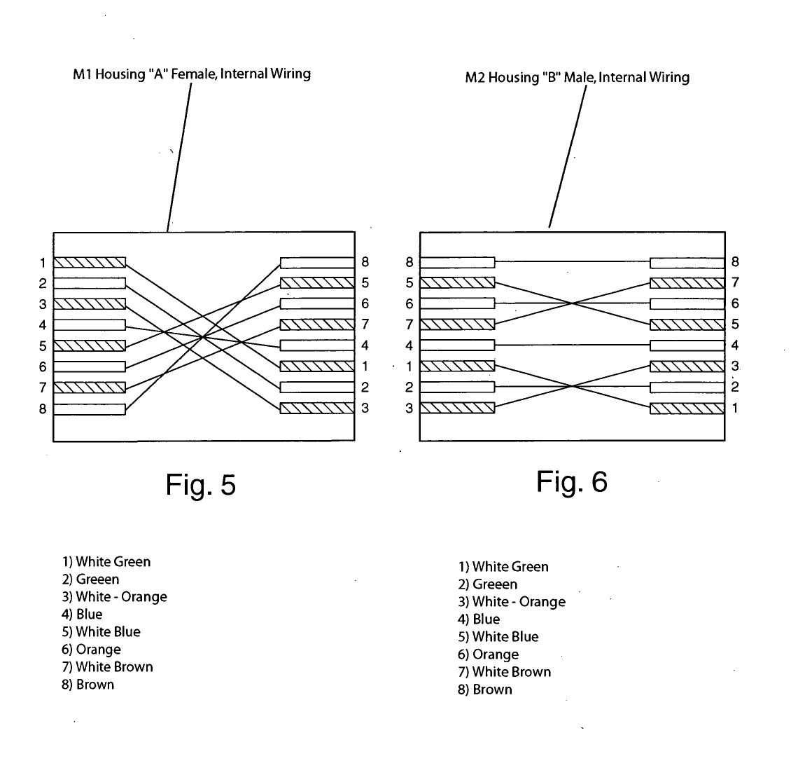

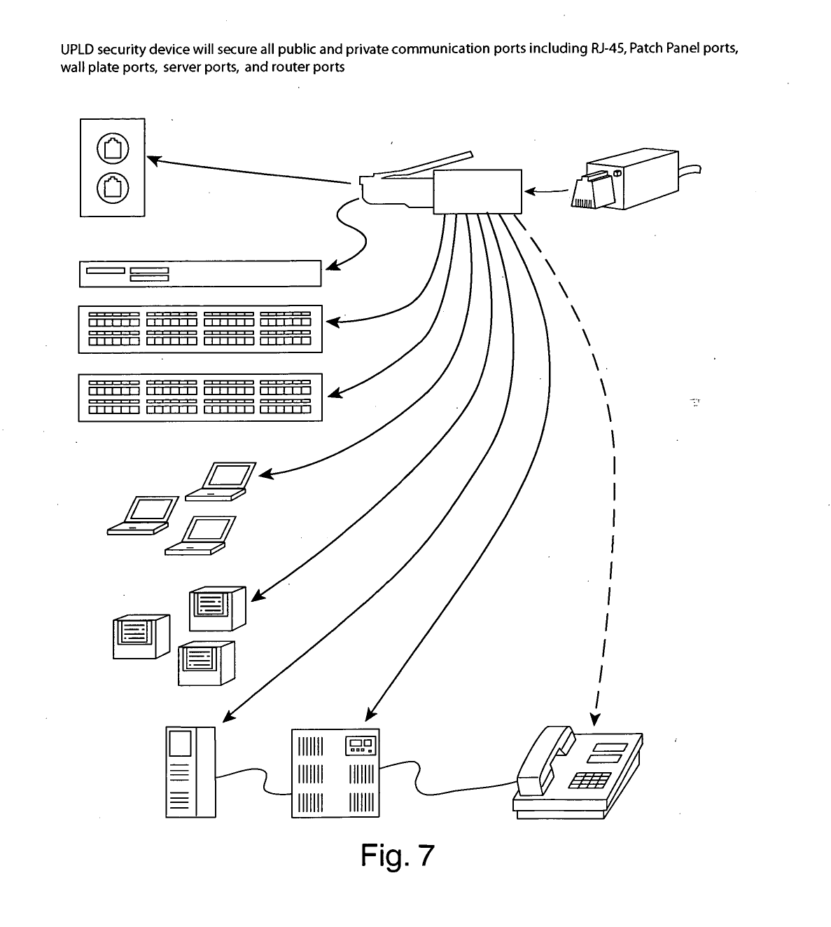

FIGS. 1 and 2 disclose how M1 possesses a unique shaped new receptacle for which M2 has been specifically designed to be complementary and will be inserted into M1, permitting access to said receptacle. FIG. 4 shows a schematic diagram of the alter alignment of the contacts in the female receptacle after M1 has been inserted. Referring now to FIG. 5, the metal teeth are generally designed as a means of locking M1 into the female communication receptacle.

The UPLD (M1) is designed to be inserted into a standardized female modular communication port, comprising, but not limited to RJ-11, RJ-14, RJ-45, USB, T1, fiber receptacle connector, or functional equivalent female receptacles. Hereafter, such female receptacles will be referred to generically as RJ-SBT. UPLDs can be used to connect a wide range of communication devices such as computer modems, fax machines, answering machines, phones,

Personal Digital Assistants (PDAs), computer receptacle ports, computer systems with cabled peripheral devices using interfaces, computer network systems, computer hard drives, and video communication ports, etc.

In an additional embodiment, M1 inserts permanently into the RJ-SBT via one-directional metal teeth-like binding means, connecting to the wire contacts on the surface of the female RJ-SBT receptacle; M1 has the capacity to modify the wiring system alignment of the contacts. The metal teeth-like binding means may be spring loaded or attached to metal hinges. However, other functional equivalent fastening means to one skilled in this art would be encompassed to achieve the fastened property.

The goal of the UPLD design concept is not to replace physical security systems or IT security systems, but to allow those systems to communicate with the best tool design to secure and prevent access to circuitry systems. Such communication leads to the prevention and stopping of hacking and spying on communication systems via accessing external RJ-SBT ports within a wide range of devices in secure and public areas. In addition, the UPLD design concept permits immediate communicable interface to perform incident response, access to data information, and remediation.

What is claimed is:

1. A Universal Port Locking Device, preventing the unauthorized use of a communication network system through female modular communication receptacle, comprising a two part modular device (M1 and M2) as shown in FIG. 1.

2. A Universal Port Locking Device of claim 1, wherein said a communication network system is selected from the group consisting of voice, audio, computer modems, fax machines, answering machines, Personal Digital Assistants (PDAs), computer receptacle ports, internal and external data-hard drives, and video communication system.

3. A Universal Port Locking Device of claim 1, wherein M1 is comprised of a fastening means, such that M1 is permanently affixed into said female modular communication receptacle.

4. A Universal Port Locking Device of claim 3, wherein said fastening means are comprised of specialized locking teeth-like structures as shown in FIG. 2.

5. A Universal Port Locking Device of M2, as shown in FIG. 3, wherein M2 is attached to a communication wire or electronic cable.

6. A Universal Port Locking Device of M1, as shown in FIG. 1, further comprising a novel wiring alignment of the circuitry contacts as shown in FIG. 5, when inserted into a female modular communication wired receptacle.

7. A method of securing a communication network system through a female modular communication receptacle by securing the female modular communication receptacle with a permanently attached Universal Port Locking Device of M1.

8. The method of claim 7, wherein said a communication network system is selected from the group consisting of voice, audio, computer modems, fax machines, answering machines, Personal Digital Assistants (PDAs), computer receptacle ports, internal and external data-hard drives, and video communication system.

9. A method of accessing a communication network system, which is secured with a Universal Port Locking Device of M1, by insertion of M2 as shown in FIG. 1.

10. The method of claim 9, wherein said a communication network system is selected from the group consisting of voice, audio, computer modems, fax machines, answering machines, Personal Digital Assistants (PDAs), computer receptacle ports, internal and external data-hard drives, and video communication system.

11. The method of claim 9, wherein M2 is attached to a communication wire or electronic cable.
